(19) United States
(12) Patent Application Publication
(10) Pub. No.: US 2026/0181350 A1
(43) Pub. Date: Jun. 25, 2026

(54) MOBILITY GRAPH-BASED DRIVER PROTECTION SYSTEM AND METHOD

(71) Applicant: Allstate Insurance Company, Northbrook, IL (US)

(72) Inventors: Matei Stroila, Northbrook, IL (US); Timothy W. Gibson, Northbrook, IL (US)

(73) Assignee: Allstate Insurance Company, Northbrook, IL (US)

(21) Appl. No.: 18/988,465

(22) Filed: Dec. 19, 2024

(51) Int. Cl. H04W 4/021; G01C 21/34; G08B 21/02

(52) U.S. Cl. CPC H04W 4/021; G01C 21/34; G08B 21/02

(57) ABSTRACT

A computing system comprises one or more processors, and one or more storage devices that comprise instruction code that is executable by the one or more processors. The instruction code is executable by the processors to cause the computing system to receive data indicative of respective locations of one or more points of interest (POIs). The computing system generates a geographic region that comprises one or more isochrone regions associated respectively with one or more POIs of a plurality of POIs. After determining that a particular driver has traveled outside the geographic region, the computing system communicates an alert indication.

### BACKGROUND

### I. Field

This application generally relates to systems for protecting at-risk drivers. In particular, this application relates to a mobility graph-based driver protection system and method.

### II. Description of Related Art

Certain categories of drivers such as teenagers, the elderly, etc., may face a higher risk of accidents when driving in unfamiliar areas due to a combination of factors. For teenagers, inexperience behind the wheel and the challenge of navigating new roads can lead to poor decision-making or slower reaction times. Elderly drivers, on the other hand, may struggle with slower reflexes, diminished vision, or cognitive decline, making it harder to adapt to unexpected changes in unfamiliar environments. Both groups may also have difficulty adjusting to unfamiliar road signs, traffic patterns, or complex intersections, increasing the likelihood of confusion and mistakes. Adverse weather conditions, such as rain, fog, or snow, can exacerbate these risks by reducing visibility and road traction, making it even more difficult for drivers to react quickly or make safe decisions. In unfamiliar areas, where drivers are already less confident, these conditions can significantly increase the chances of accidents.

### SUMMARY

In a first aspect, a computing system comprises one or more processors, and one or more storage devices that comprise instruction code that is executable by the one or more processors. The instruction code is executable by the processors to cause the computing system to receive data indicative of respective locations of one or more points of interest (POIs). In some examples, this involves receiving location data that specifies a plurality of geographic locations at which a mobile device was present. After determining that a number of times the mobile device was present at a particular geographic location exceeds a threshold, the computing system indicates the particular geographic location as a point of interest (POI). The computing system generates a geographic region that comprises one or more isochrone regions associated respectively with one or more POIs of a plurality of POIs. After determining that a particular driver has traveled outside the geographic region, the computing system communicates an alert indication.

In a second aspect, a non-transitory computer-readable medium has stored there on instruction code that is executable by one or more processors of a computing system to cause computing system to receive location data that specifies a plurality of geographic locations at which a mobile device was present. After determining that a number of times the mobile device was present at a particular geographic location exceeds a threshold, the computing system indicates the particular geographic location as a point of interest (POI). The computing system generates a geographic region that comprises one or more isochrone regions associated respectively with one or more POIs of a plurality of POIs. After determining that a particular driver has traveled outside the geographic region, the computing system communicates an alert indication.

In a third aspect, a computer-implemented method comprises receiving information location data that specifies a plurality of geographic locations at which a mobile device was present. After determining that a number of times the mobile device was present at a particular geographic location exceeds a threshold, the particular geographic location is indicated to be a point of interest (POI). A geographic region that comprises one or more isochrone regions associated respectively with one or more POIs of a plurality of POIs is generated. After determining that a particular driver has traveled outside the geographic region, an alert indication is communicated.

### BRIEF DESCRIPTION OF THE DRAWINGS

The accompanying drawings are included to provide a further understanding of the claims, are incorporated in, and constitute a part of this specification. The detailed description and illustrated examples described serve to explain the principles defined by the claims.

FIG. 1 illustrates an environment that includes various systems/devices that encourage such at-risk drivers to operate vehicles within geographic regions where they are more likely to be familiar and comfortable, in accordance with example embodiments.

FIG. 2 illustrates a mobile device, in accordance with example embodiments.

FIG. 3 illustrates a vehicle, in accordance with example embodiments.

FIG. 4 illustrates a driver protection system (DPS), in accordance with example embodiments.

FIG. 5 illustrate operations that encourage at-risk drivers to operate vehicles within geographic regions they are more likely to be familiar and/or comfortable with, in accordance with example embodiments.

FIGS. 6A and 6B show points of interest (POIs) and various roadways interconnecting the POIs, in accordance with example embodiments.

FIG. 7 illustrates operations for alerting an at-risk driver when the at-risk driver leaves a geographic region, in accordance with example embodiments.

FIG. 8 illustrates operations for routing an at risk driver from a first geographic location to a second geographic location, in accordance with example embodiments.

FIGS. 9A and 9B show routes generated by the DPS between the first geographic location to the second geographic location, in accordance with example embodiments.

FIG. 10 illustrates a computer system that can form part of or implement any of the systems and/or devices described above, in accordance with example embodiments.

### DETAILED DESCRIPTION

Various examples of systems, devices, and/or methods are described herein. Any embodiment, implementation, and/or feature described herein as being an “example” is not necessarily to be construed as preferred or advantageous over any other embodiment, implementation, and/or feature unless stated as such. Thus, other embodiments, implementations, and/or features may be utilized, and other changes may be made without departing from the scope of the subject matter presented herein.

Accordingly, the examples described herein are not meant to be limiting. It will be readily understood that the aspects of the present disclosure, as generally described herein, and illustrated in the figures, can be arranged, substituted, combined, separated, and designed in a wide variety of different configurations.

Further, unless the context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Further, terms such as “A coupled to B” or “A is mechanically coupled to B” do not require members A and B to be directly coupled to one another. It is understood that various intermediate members may be utilized to “couple” members A and B together.

Moreover, terms such as “substantially” or “about” that may be used herein, are meant that the recited characteristic, parameter, or value need not be achieved exactly but that deviations or variations, including, for example, tolerances, measurement error, measurement accuracy limitations and other factors known to skill in the art, may occur in amounts that do not preclude the effect the characteristic was intended to provide.

### III. Introduction

As noted above, certain categories of drivers such as teenagers, the elderly, etc., may face a higher risk of accidents when driving in unfamiliar areas due to a combination of factors. Disclosed herein are examples of driving protection systems (DPS) and methods performed by the systems that encourage such at-risk drivers to operate vehicles within geographic regions where they are more likely to be familiar and comfortable. These geographic regions are hereinafter referred to as safe driving regions. When the at-risk driver drives within these safe driving regions, the likelihood of the at-risk driver being involved in an accident is reduced. This reduction in the likelihood of being involved in an accident lowers the risk profile associated with the at-risk driver 112.

In this regard, some examples of the DPS receive location data that specifies a plurality of geographic locations at which a mobile device was present. In some examples, the mobile device belongs to the at-risk driver, thereby indicating the driver's location. In some examples, the location data is received from one or more mobile devices of one or more other individuals associated with the at-risk driver (e.g., the parents of a teenager, one or more caregivers of an elderly person, etc.), thereby indicating where those individuals have been. In some examples, the location data may be associated with other individuals previously determined to have characteristics in common with the at-risk driver, such as similarly aged individuals living in the same area as the at-risk driver 112.

In some examples, the DPS determines, based on the location data, the number of times the at-risk driver, the individuals associated with the at-risk driver, etc., were present at various geographic locations. When a particular geographic location has been visited greater than a threshold number of times, the DPS indicates the particular geographic location as a point of interest (POI).

After determining the POIs, the DPS generates isochrone regions for one or more of the POIs. Each isochrone region defines an area around the geographic location of a corresponding POI that is reachable via roadway within a threshold amount of time when traveling from the geographic location. For example, a first isochrone region associated with a local school may include all neighborhoods within a 5-minute drive to the school. A second isochrone region associated with a local train station may include all neighborhoods within a 5-minute drive to the train station. Etc.

After determining the isochrone regions for the POIs, the DPS clusters different groups of isochrone regions to form larger geographic regions. These geographic regions correspond to the safe driving regions described earlier where the at-risk driver may be more familiar and comfortable driving. In some examples, after determining the safe driving regions, the DPS tracks the location of the at-risk driver 112. When the DPS determines that the at-risk driver has traveled outside the safe driving regions, the DPS communicates an alert indication. For example, the DPS may communicate the alert indication to the mobile device of the at-risk driver and/or to the mobile devices of one or more other individuals associated with the at-risk driver 112.

In some instances, the safe driving regions determined above may be far apart. For instance, the two safe driving regions may correspond to distinct towns. There may be multiple routes one can take to traverse between them and some of these routes may be more easily managed by the at-risk driver than others. In some examples, the DPS receives a request for a route between the safe driving regions that can be more easily managed by the at-risk driver 112. Some examples of the DPS determines a particular route based on a variety of factors such as the respective speed limits of the roadways that make up the route, whether there is traffic on the roadways, etc. In some examples, determination of a particular route is further based on the at-risk driver's driving skill level (e.g., 0 for poor driving skills, 10 for excellent driving skills). In some examples, the driving skill level may be based on the age of the driver, how often the at-risk driver drives, where the at-risk driver drives, whether the at-risk driver has any impairments (e.g., visual impairments), etc. These aspects about the at-risk driver may be communicated to the DPS during a setup process. For example, the parent of a teenager, caregiver of an elderly person, etc., may generate an account with the DPS and specify this and other information to the DPS during the account setup procedures.

After determining a specific route, the DPS determines an isochrone region for that route. When the at-risk driver is operating outside of this isochrone region, the DPS may generate an alert indication. For instance, if the route selected for the at-risk driver is a particular stretch of roadway, the at-risk driver may be permitted to deviate from the route to the extent permitted by the isochrone region before triggering the alert indication. This flexibility may allow the at-risk driver to deviate from the route to, for example, obtain fuel, food, or other necessities from an establishment that is relatively close (e.g., within a five-minute drive) to the route, without triggering an alert. However, if the at-risk driver strays further the DPS, communicates the alert indication.

As previously noted, the methodologies and systems outlined above can lower the risk profile associated with the at-risk driver 112. In this regard, in some examples, whether the at-risk driver has operated a vehicle within one or more safe driving regions (i.e., where they are more likely to be familiar and comfortable) is communicated to a 3^{rd} party system such as an insurance system. For instance, the DPS may communicate to an insurance system a first indication when the at-risk driver is operating a vehicle within one or more safe driving regions and a second indication when the at-risk driver is operating the vehicle outside of a safe driving region. The insurance system may for example adjust an insurance premium associated with the at-risk driver based on how often the at-risk driver drives within safe driving regions.

### IV. Example Environment

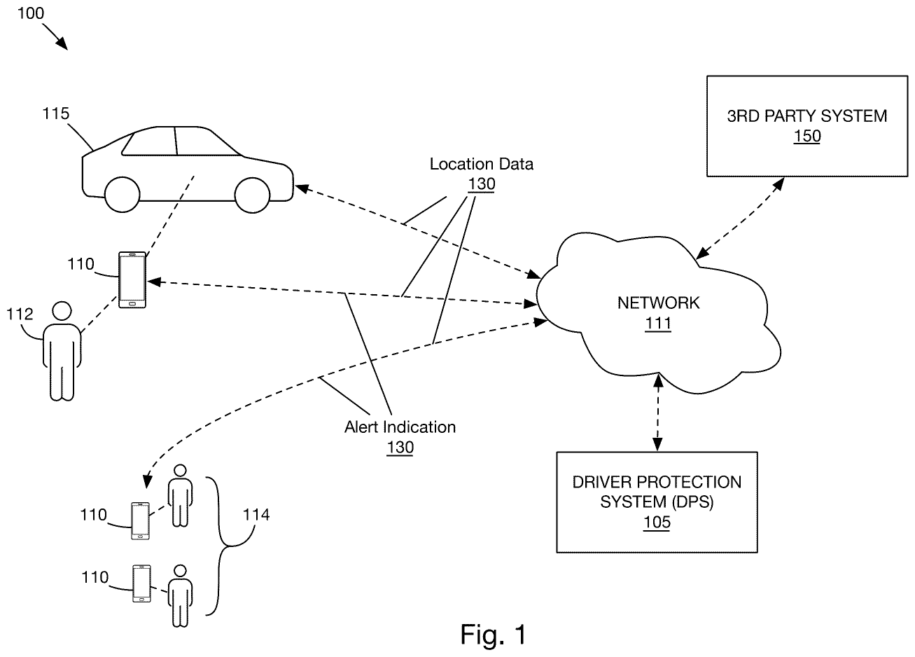

FIG. 1 illustrates an example of an environment 100 that includes various systems/devices that encourage such at-risk drivers 112 to operate vehicles within safe geographic regions. Example systems/devices of the environment 100 include a driver protection system 105 (DPS), a mobile device 110, a 3^{rd} party system 150, and a vehicle 115. As described in further detail below, some examples of the DPS 105 are configured to receive location data 130 aggregated by location circuitry of a mobile device 110 or vehicle 115 associated with an at-risk driver 112 or from one or more mobile devices 110 associated with other users 114 associated with the at-risk driver 112. The receipt of location data 130 by the DPS 105 allows the DPS 105 to ascertain whether the at-risk driver 112 is operating the vehicle 115 within a safe driving region. When the at-risk driver 112 is not driving within safe driving region, the DPS 105 may communicate an alert indication 130 to the at-risk driver 112 and/or the other user 114. In some examples, the DPS 105 communicates the alert indication 130 or a different indication that indicates whether the at-risk driver 112 is driving within a safe driving region to the 3^{rd} party system.

In some examples, the DPS 105, mobile device 110, and vehicle 115 communicate information to one another via a communication network 111, such as the Internet, a cellular communication network, a WiFi network, etc.

### A. Example Mobile Devices

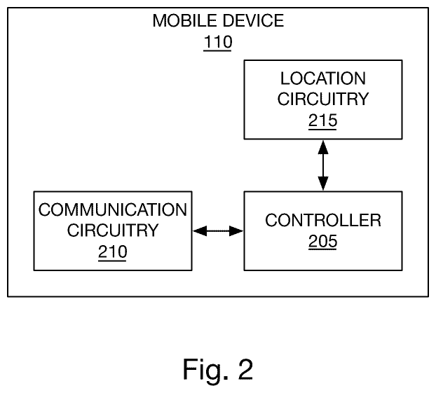

FIG. 2 illustrates an example of a mobile device 110. Some examples of the mobile device 110 correspond to cellular telephones, tablets, etc. Some examples of the mobile device 110 communicate via a cellular telephone network, such as GSM, LTE, 5G, etc., cellular networks. As shown in the figure, some examples of the mobile device 110 include a controller 205, communication circuitry 210, and location circuitry 215.

Some examples of the controller 205 comprise a processor and a memory that is in communication with the processor. The processor is configured to execute instruction code stored in the memory. The instruction code facilitates performing, by the mobile device 110, various operations that are described herein. In this regard, the instruction code may cause the processor to control and coordinate various activities performed by the different subsystems of the mobile device 110. Some examples of the processor correspond to an ARM®, Intel®, AMD®, PowerPC®, etc., based processor. Some examples of instruction code stored in the memory and executed by the processor implement an operating system, such as Android ™, IOS®, Windows ®, Linux ®, or a different operating system.

Some examples of the communication circuitry 210 comprise circuitry that facilitates wired and/or wireless communications with other devices or systems. An example of the wireless communication circuitry includes cellular telephone communication circuitry configured to communicate information over a cellular telephone network such as a 3G, 4G, and/or 5G network. Other examples of the wireless communication circuitry facilitate communication of information via an 802.11 based network, Bluetooth®, Zigbee®, near-field communication technology or a different wireless network.

Some examples of the location circuitry 215 correspond to global positioning system circuitry (GPS circuitry) configured to determine the geographic location of the mobile device 110 based on signals received from a constellation of satellites. Some examples of the location circuitry 215 are configured to determine the location of the mobile device 110 based on signals received from one or more cellular communication towers. Some examples of the location circuitry periodically (e.g., every second) determine the location (e.g., latitude and longitude) of the mobile device 110. In this regard, in some examples, location data 130 communicated by the mobile device 110 includes latitude/longitude samples that specify the latitude/longitude of the mobile device 110 and a timestamp that indicates a time at which the mobile device 110 was at a particular location. In some examples, the location circuitry 215 outputs location data 130 at a particular sample rate, such as 1 sample per second (i.e., at a 1 Hz sample rate)

In operation, when the mobile device 110 is situated within a vehicle 115, one or more readings from the location circuitry 215 can be used to ascertain the vehicle's position as well as its kinematic characteristics, such as the vehicle's speed. This information can, in turn, be used to determine one or more routes the vehicle 115 has taken. In some examples, the information gathered by the mobile device 110 and associated with the vehicle 115 is uploaded to the DPS 105 and/or other systems/devices. For instance, in some examples, the information is stored within a storage device of the vehicle (e.g., a telematics device) and the device communicates the information to the DPS 105 periodically, according to a schedule, etc.

### B. Example Vehicles

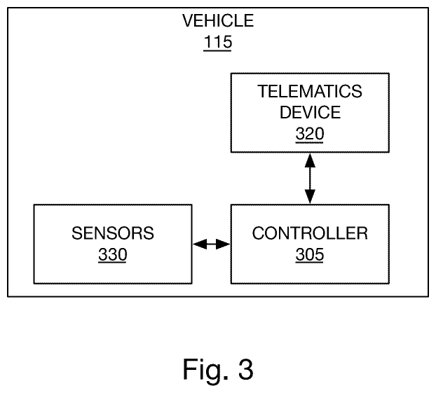

FIG. 3 illustrates an example of a vehicle 115. Some examples of the vehicle 115 correspond to an automobile, motorcycle, etc. As shown in the figure, some examples of the vehicle 115 include a controller 305, a telematics device 320, and one or more sensors 330.

Some examples of the controller 305 comprise a processor and a memory and/or data storage device that is in communication with the processor. The processor is configured to execute instruction code stored in the memory. The instruction code facilitates performing, by the vehicle 115, various operations that are described herein. In this regard, the instruction code may cause the processor to control and coordinate various activities performed by the different subsystems of the vehicle 115. Some examples of the processor correspond to an ARM®, Intel®, AMD®, PowerPC®, etc., based processor. Some examples of instruction code stored in the memory and executed by the processor implement an operating system, such as Android ™, IOS®, Windows ®, Linux ®, or a different operating system.

Some examples of the telematics device 320 collect and wirelessly communicate data about that vehicle's performance and location. In this regard, some examples of the telematics device 320 are configured to communicate (e.g., via the onboard diagnostic (OBD) port of the vehicle 115) with the controller 305 of the vehicle 115 to obtain information that is sensed/recorded by one or more of the sensors 330. In some examples, information collected by the telematics device 320 is communicated to an insurance processing server (IPS) and analyzed by the IPS to facilitate determining an appropriate and/or personalized insurance policy for the driver of the vehicle 115. Such a policy may encourage the driver to adopt safe driving practices, which, in some instances, can lead to lower insurance premiums for the driver.

Some examples of the telematics device 320 comprise circuitry that facilitates wireless communications with other devices or systems. An example of the wireless communication circuitry includes cellular telephone communication circuitry configured to communicate information over a cellular telephone network such as a 3G, 4G, and/or 5G network. Other examples of the wireless communication circuitry facilitate communication of information via an 802.11 based network, Bluetooth®, Zigbee®, near-field communication technology or a different wireless network. Some examples of the telematics device 320 comprise location circuitry (e.g., circuitry that receives signals from one or more global navigation satellite systems (GNSSs)), which facilitates real-time location tracking of the vehicle 115.

In some examples, one or more readings sensed by the sensors 330 are associated with a timestamp. The timestamp facilitates determining afterward a particular period during which particular sensed values were captured.

In some examples, values obtained by the sensors 330 are stored within the vehicle 115. In some examples, the values obtained by the sensors 330 are communicated to one or more remote systems for storage and/or for further analysis. For example, the controller 305 and/or the telematics device may directly or indirectly (e.g., via the mobile device 110) communicate the obtained values to the DPS 105. In some examples, one or more of the values obtained by the sensors are communicated to the remote systems in real-time, uploaded to the remote systems according to a schedule (e.g., once a week), and/or uploaded to the remote systems when a storage device of the vehicle 115 upon which the values are stored becomes full.

### c. Example Driver Protection System

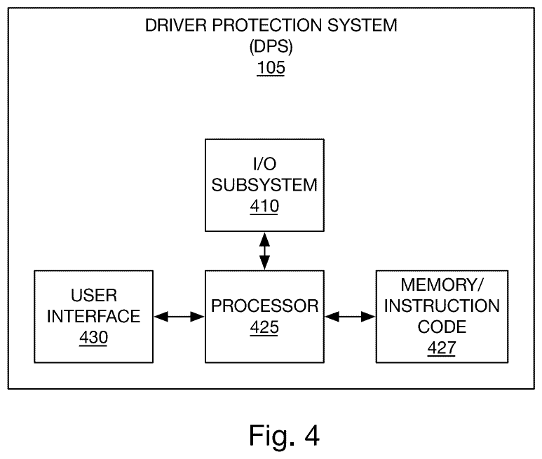

FIG. 4 illustrates an example of a driver protection system 105 (DPS). Referring to the figure, the DPS 105 includes a memory 427, a processor 425, a user interface 430, and an input/output (I/O) subsystem 410.

The processor 425 is in communication with the memory 427 and is configured to execute instruction code stored in the memory 427. The instruction code facilitates performing, by the DPS 105, various operations that are described herein. In this regard, some examples of the instruction code cause the processor 425 to control and coordinate various activities performed by the different subsystems of the DPS 105. Some examples of the processor 425 correspond to a stand-alone computer system such as an ARM®, Intel®, AMD®, or PowerPC® based computer system or a different computer system and can include application-specific computer systems. Some examples of the computer system include an operating system. Examples of the operating system include Android™, Windows®, Linux®, Unix®, or a different operating system.

Some examples of the I/O subsystem 410 include one or more input/output interfaces configured to facilitate communications with entities outside of the DPS 105. Some examples of the I/O subsystem 410 include wireless communication circuitry configured to facilitate communicating information to and from the DPS 105. Examples of the wireless communication circuitry include cellular telephone communication circuitry configured to communicate information over a cellular telephone network such as a 3G, 4G, and/or 5G network. Other examples of the wireless communication circuitry facilitate the communication of information via a WiFi-based network, Bluetooth®, Zigbee®, near-field communication technology or a different wireless network.

Some examples of the I/O subsystem 410 are configured to communicate information via a RESTful API or a Web Service API. Some examples of I/O subsystem 410 implement a web server to facilitate generating one or more web-based interfaces through which users of the DPS 105 and/or other systems interact with the DPS 105.

### V. Example Operations

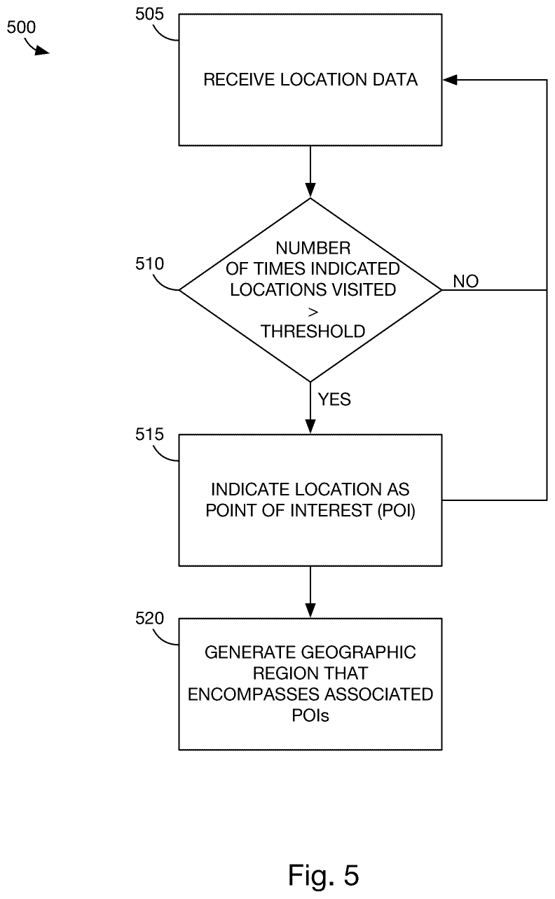

As previously noted, certain categories of drivers such as teenagers, the elderly, etc., may face a higher risk of accidents when driving in unfamiliar areas due to a combination of factors. FIGS. 5-9B illustrate examples of operations 500 that ensure that such at-risk drivers 112 operate vehicles within geographic regions they are more likely to be familiar and/or comfortable with. These operations are performed by some examples of the systems described above (e.g., the DPS 105, the mobile device 110, the vehicle 115, etc.). In some examples, one or more of these operations are implemented via instruction code, stored in corresponding data storage (e.g., memory 427) of these systems. Execution of the instruction code by corresponding processors of the systems causes these systems to perform these operations alone or in combination with other systems and/or devices.

The operations at block 505 involve the DPS 105 receiving location data 130. Some examples of the location data 130 comprise geographic location samples (e.g., latitude, longitude, altitude, etc.) at which a mobile device 110 was present. In some examples, the location samples are received in real-time. For example, the mobile device 110 may generate a location sample every 30 seconds and communicate a location sample to the DPS 105 immediately or as soon as possible thereafter. In some examples, the mobile device 110 may store location samples for a period before communicating them to the DPS 105. For example, the mobile device 110 may accumulate location samples for a day and then communicate those samples to the DPS 105 at the end of the day.

In some examples, the mobile device 110 belongs to the at-risk driver 112. As such, the location samples may indicate various locations visited by the at-risk driver 112. Some of these locations may have been visited more often than other locations. Those locations visited more often are more likely to be familiar to the at-risk driver 112, whereas locations visited less frequently may not be as familiar to the at-risk driver 112. In some examples, the mobile device 110 belongs to another user 114 associated with the at-risk driver 112. For example, the mobile device 110 may belong to the parent of a teenager or the caregiver of the elderly person.

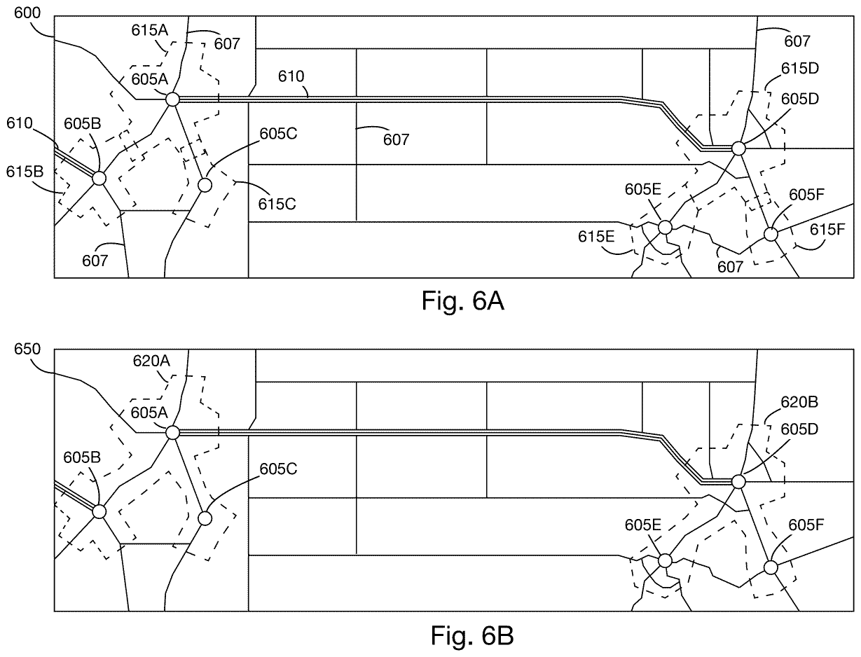

The operations at block 510 involve the DPS 105 determining whether the number of times the mobile device 110 was present at various geographic locations exceeds a threshold number of times. If the number of times the mobile device 110 was present at a particular geographic location exceeds a threshold number, then the operations at block 515 may be performed. The operations at block 515 involve the DPS 105 indicating the particular location as a point of interest (POI) 605 (FIG. 6A). In some examples, the DPS 105 determines the mobile device 110 to have visited a particular location after receiving a threshold number of location samples (e.g., ten samples) during a predetermined period (e.g., one hour) indicating the same location. For example, the mobile device 110 may be at a particular residence, place of business, etc., for several hours and may generate numerous location samples indicating the location of the residence, place of business, etc., during that time. As such, the DPS 105 may determine that the residence, place of business, etc., was visited. In certain instances, the next visit to a specific location may not be determined until after the mobile device 110 leaves that location. For instance, if the mobile device 110 remains at the location for an extended duration, it's considered a single visit. However, if the device leaves the location and subsequently returns, the subsequent visit is regarded as a second visit.

The operations at block 517 involve receiving one or more user-specified POIs. In some examples, user-specified POIs are specified via a device (e.g., a mobile device 110) that belongs to the at-risk driver 112. In some examples, the user-specified POIs are specified by and/or via a device that belongs to another user 114 associated with the at-risk driver 112 such as the parent of a teenager or the caregiver of an elderly person. Some examples of the user-specified the POIs are defined in terms of latitude and longitude values. Some examples of the user-specified the POIs are defined in terms of particular addresses. In some examples, the user may be presented with a graphical user interface through which one or more POIs may be specified. Some examples of the graphical user interface comprise one or more fields through which latitude and longitude values, addresses, etc., of the POIs can be specified. Some examples of the graphical user interface comprise a map configured to receive a user gesture, such as a tap or selection of a particular area of the map, that is indicative of one or more POIs.

The operations at block 520 involve the DPS 105 generating a safe driving regions that comprises one or more isochrone regions 615 associated respectively with one or more POIs 605 determined and/or specified above. The operations performed at block 520 are more clearly understood with reference to the map sections 600, 650 illustrated in FIGS. 6A and 6B.

The map section 600 of FIG. 6A shows several POIs 605 and various roadways (e.g., side streets 607, highways 610, etc.,) that interconnect the POIs 605. The respective locations of the POIs 605 may have been determined according to the operations performed in block 515 and/or directly specifies according to the operations performed in block 527.

In some examples, after the POIs 605 are determined or specified, isochrone regions 615 associated with respective POIs 605 are generated. Each isochrone region 615 defines a geographic region around a corresponding POI 605 that is reachable via roadway within a threshold amount of time. For example, the isochrone region 615 for a particular POI 605 defines the geographic region reachable from the POI 605 when traveling via vehicle 115 for five minutes. Some example techniques for determining the isochrone regions 615 involve creating a graph of connected points (nodes) such as roads, paths, or transit routes, with edges representing travel times between them. In some examples, algorithms such as Dijkstra's or “A-star” (A*) are used to calculate the shortest time from the point of interest to all other nodes. In some examples, various transportation modes and constraints, such as road speed limits or public transport schedules information, which may be received from one or more Geographic Information Systems (GIS) tools, are factored in when generating the isochrone regions. Additionally, in some examples, real-time data, such as traffic or transit schedules, is factored in for more dynamic isochrone calculations.

As shown in the map section 650 of FIG. 6B, in some examples, after generating the isochrone regions 615, uninterrupted clusters of overlapping isochrone regions 615 are joined together to form a larger geographic region. For example, the isochrone regions 615A through 615C, which overlap one another, are joined together to form a first geographic region or a first safe driving region 620A and isochrone regions 615D through 615F, which overlap one another, are joined together to form a second geographic region or a second safe driving region 620B.

In some examples, an interface that incorporates the map section 950, which includes the generated isochrone regions 615, is communicated to the device of the at-risk driver 112 and/or one or more other users 114 associated with the at-risk driver 112 (e.g., the parent of a teenager, the caregiver of an elderly person, etc.). In some examples, the interface is configured to allow a user (such as the at-risk driver, parent, caregiver, etc.) to modify the generated isochrone regions 615. For instance, the interface may be configured to allow the user to expand and/or contract the respective safe driving regions 620 to encompass and/or exclude different regions depicted on the map section 650. In some examples, the interface is configured to permit the user to specify one or more additional POIs and/or remove one or more POIs. Following the specification and/or removal of the POIs, the operations at block 520 for generating the safe driving regions may be executed once more. This process may continue until the user is content with the isochrone region 615 results.

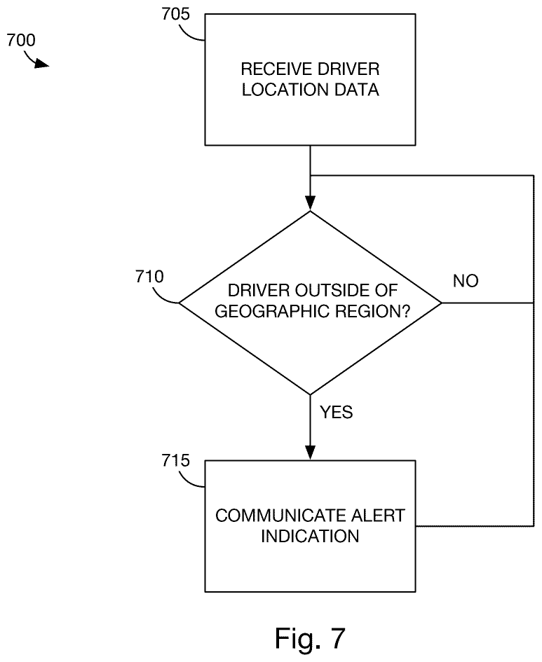

After the safe driving regions 620 are generated and/or finalized, the operations 700 of FIG. 7 are performed. Referring to FIG. 7, the operations at block 705 involve receiving at-risk driver location data 130. The at-risk driver's location may be determined via location data 140 communicated from the at-risk driver 112 mobile device 110 or vehicle 115.

The operations at block 710 involve determining whether the at-risk driver 112 is within a safe driving region 620 such as the first safe driving region 620A or the second safe driving region 620B described in regard to FIG. 6B. If the at-risk driver 112 is not within a safe driving region 620, then the operations at block 715 are performed. These operations involve generating an alert indication 130. In some examples, the alert indication 130 is communicated to the mobile device 110 of the at-risk driver 112. In some examples, after receiving the alert indication 130, the mobile device 110 generates an audible or a visual alert. An example of an audible alert may instruct the at-risk driver 112 to turn around. An example of the visual alert may depict a route the at-risk driver 112 can take to return to a safe driving region 620. Alternatively, or additionally, the alert indication 130 may be communicated to a user 114 associated with the at-risk driver 112, such as the parent of a teenager, the caregiver of an elderly person, etc. In some examples, the alert indication 130 communicated to the user 114 may indicate the location of the at-risk driver 112 to facilitate showing the location of the at-risk driver 112 on a graphical user interface of a user device of the user 114.

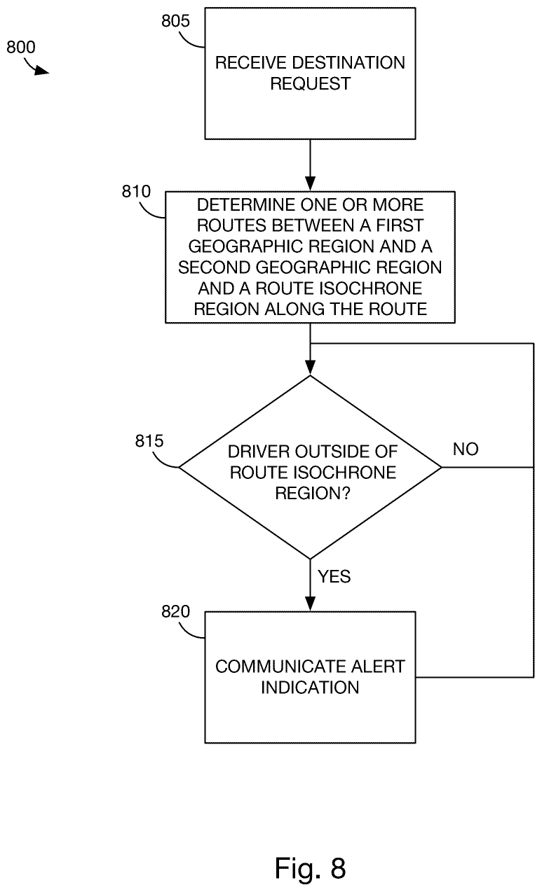

FIG. 8 illustrates examples of operations 800 for routing an at-risk driver 112 from a first safe driving region 620A to a second safe driving region 620B. In some examples, the at-risk driver 112 is familiar and comfortable with driving in the first safe driving region 620A and the second safe driving region 620B such that driving within those locations does not pose a heightened risk for the at-risk driver 112.

The operations at block 805 involve the DPS 105 receiving a destination request. For example, the at-risk driver 112 may communicate (e.g., via the mobile device 110) a request for a route to take the at-risk driver 112 from the first safe driving region 620A to the second safe driving region 620B. In some examples, another user 114 associated with the at-risk driver 112 (e.g., parent, caregiver, etc.) may communicate the request for the route.

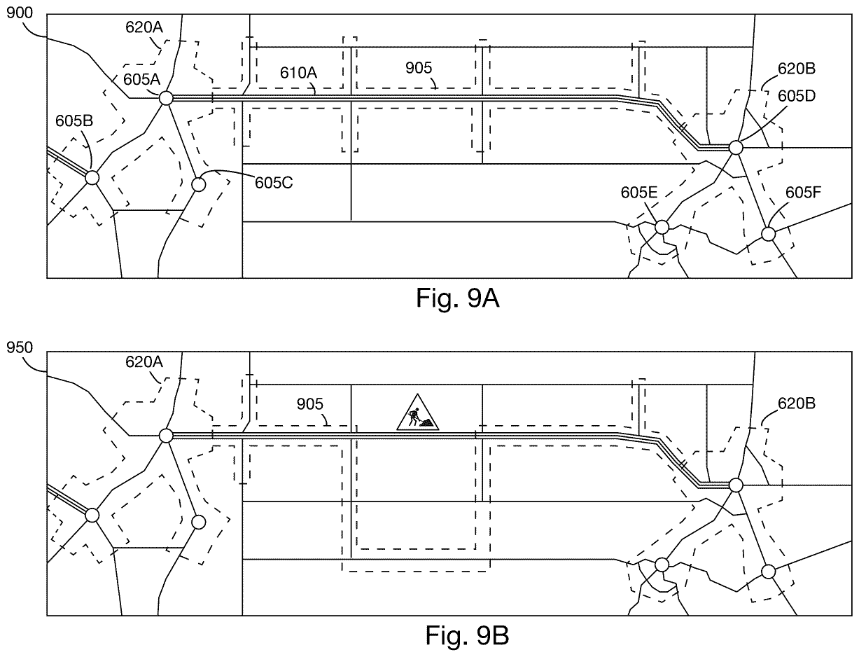

The operations at block 810 involve the DPS 105 determining one or more routes between the first safe driving region 620A and the second safe driving region 620B and a route isochrone region 905 (FIG. 9). For example, algorithms such as Dijkstra's and A-star (A*), among others, may be used to determine one or more routes between a POI 605 in the first safe driving and a POI 605 in the second safe driving along with the travel time associated with each route. Determination of the travel time may be based on a variety of factors, such as the respective speed limits of the roadways that make up the route, whether there is traffic on the roadways, etc. In some examples, the route associated with the shortest time is selected and indicated to the at-risk driver 112. For example, referring to map section 900 of FIG. 9A, a particular highway 610A may correspond to the fastest route between the first safe driving region 620A and the second safe driving region 620B. After determining a route, the DPS 105 determines a route isochrone region 905 to associate with the route. The route isochrone region 905 defines a geographic region around the corresponding route that is reachable via roadway within a threshold amount of time (e.g., five minutes) when traveling via a vehicle 115. For example, as previously noted, the route in FIG. 9A may comprise a highway 610A. The route isochrone region 905 may comprise the highway 610A and one or more side roads or side road sections reachable from the highway 610A within, e.g., five minutes.,

The operations at block 815 involve DPS 105 determining whether the at-risk driver 112 is driving outside of the route isochrone region 905. If the at-risk driver 112 outside of the route isochrone region 905, then the operations at block 825 are performed. These operations involve generating an alert indication 130, such as the alert indication 130 described above in regard to block 710 in FIG. 7. For instance, in some examples, the mobile device 110 generates an audible or a visual alert. An example of an audible alert may instruct the at-risk driver 112 to turn around. An example of the visual alert may depict a route that the at-risk driver 112 can take to return to a safe driving region 620. Alternatively, or additionally, the alert indication 130 may be communicated to a user 114 associated with the at-risk driver 112, such as the parent of a teenager, the caregiver of an elderly person, etc. In some examples, the alert indication 130 communicated to the user 114 may indicate the location of the at-risk driver 112 to facilitate showing the location of the at-risk driver 112 on a graphical user interface of a user device of the user 114.

As noted above, in some examples, the determination of a particular route is based on a variety of factors, such as the respective speed limits of the roadways that make up the route, whether there is traffic on the roadways, etc. In some examples, the determination of a particular route is further based on the at-risk driver's driving skill level (e.g., 0 for poor driving skills, 10 for excellent driving skills). In some examples, the driving skill level may be based on the age of the at-risk driver 112, how often the at-risk driver 112 drives, where the at-risk driver 112 drives, whether the at-risk driver 112 has any impairments (e.g., visual impairments), etc. In some examples, the DPS 105 may determine the driving skill level based on information received during the at-risk driver setup process described above. For example, the parent of a teenager, caregiver of an elderly person, etc., may provide this information during the setup process. For example, the parent of a teenage child may indicate that the child hasn't driven on highways very often. In this case, the DPS 105 may generate the route 910 indicated in the maps section 950 of FIG. 9B, which comprises a combination of highways and side roads selected to avoid a section of the highway that is under construction, which may be more challenging for the at-risk driver 112 to navigate.

### VI. Example Computer Systems

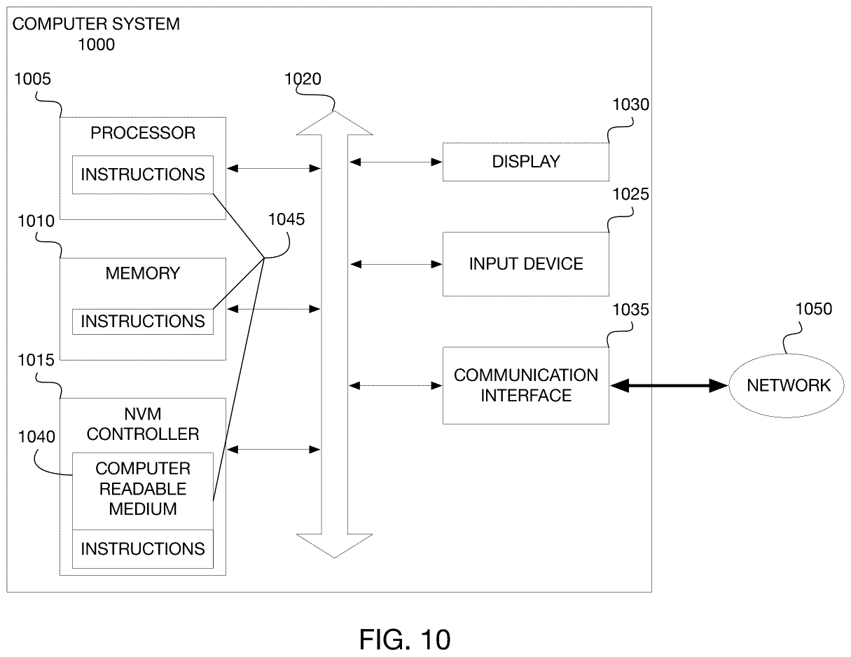

FIG. 10 illustrates an example of a computer system 1000 that can form part of or implement any of the systems and/or devices described above. The computer system 1000 can include a set of instructions 1045 that the processor 1005 can execute to cause the computer system 1000 to perform any of the operations described above. An example of the computer system 1000 can operate as a stand-alone device or can be connected, e.g., using a network, to other computer systems or peripheral devices.

In a networked example, the computer system 1000 can operate in the charge capacity of a server as a client computer in a server-client network environment or as a peer computer system in a peer-to-peer (or distributed) environment. The computer system 1000 can also be implemented or incorporated into various devices, such as a personal computer or a mobile device 110, capable of executing instructions 1045 (sequential or otherwise), causing a device to perform one or more actions. Further, each of the systems described can include a collection of subsystems that individually or jointly execute a set, or multiple sets, of instructions to perform one or more computer operations.

The computer system 1000 can include one or more memory devices 1010 communicatively coupled to a bus 1020 for communicating information. In addition, code operable to cause the computer system to perform operations described above can be stored in the memory 1010. The memory 1010 can be random-access memory, read-only memory, programmable memory, or any other type of memory or storage device.

The computer system 1000 can include a display 1030, such as a liquid crystal display (LCD), organic light-emitting diode (OLED) display, or any other display suitable for conveying information. The display 1030 can act as an interface for the user to see processing results produced by processor 1005.

Additionally, the computer system 1000 can include an input device 1025, such as a keyboard or mouse or touchscreen, configured to allow a user to interact with components of system 1000.

The computer system 1000 can also include a non-volatile memory (NVM) controller 1015. The NVM controller 1015 can include a computer-readable medium 1040 (e.g., flash drive) in which the instructions 1045 can be stored. The instructions 1045 can reside completely, or at least partially, within the memory 1010 and/or within the processor 1005 during execution by the computer system 1000. The memory 1010 and the processor 1005 can also include computer-readable media, as discussed above.

The computer system 1000 can include a communication interface 1035 to support communications via a network 1050. The network 1050 can include wired networks, wireless networks, or combinations thereof. The communication interface 1035 can enable communications via any number of wireless broadband communication standards.

Accordingly, methods and systems described herein can be realized in hardware, software, or a combination of hardware and software. The methods and systems can be realized in a centralized fashion in at least one computer system or in a distributed fashion where different elements are spread across interconnected computer systems. Any kind of computer system or other apparatus adapted for carrying out the methods described herein can be employed.

The methods and systems described herein can also be embedded in a computer program product, which includes all the features enabling the implementation of the operations described herein and which, when loaded in a computer system, can carry out these operations. Computer program as used herein refers to an expression, in a machine-executable language, code or notation, of a set of machine-executable instructions intended to cause a device to perform a particular function, either directly or after one or more of a) conversion of a first language, code, or notation to another language, code, or notation; and b) reproduction of a first language, code, or notation.

While the systems and methods of operation have been described with reference to certain examples, it will be understood by those skilled in the art that various changes can be made and equivalents can be substituted without departing from the scope of the claims. Therefore, it is intended that the present methods and systems not be limited to the particular examples disclosed, but that the disclosed methods and systems include all embodiments falling within the scope of the appended claims.

What is claimed is:

1. A computing system comprising:
one or more processors; and
one or more storage devices that comprise instruction code that is executable by the one or more processors to cause the computing system to:
receive data indicative of respective locations of one or more points of interest (POIs);
generate a geographic region that comprises one or more isochrone regions associated respectively with the one or more POIs; and
after determining that a particular driver has traveled outside the geographic region, communicate an alert indication.

2. The computing system according to claim 1, wherein the instruction code that causes the computing system to receive data indicative of the respective locations of the one or more POIs causes the computing system to:
receive location data that specifies a plurality of geographic locations at which a mobile device was present;
after determining that a number of times the mobile device was present at a particular geographic location exceeds a threshold, indicate the particular geographic location as a point of interest (POI).

3. The computing system according to claim 1, wherein the instruction code that causes the computing system to receive data indicative of the respective locations of the one or more POIs causes the computing system to:
cause a user device to:
display an interface configured to receive an indication of one or more user-specified POIs; and
after receiving the indication, communicate the data indicative of the one or more user-specified POIs to the computing system.

4. The computing system according to claim 1, wherein the one or more isochrone regions comprise respective areas around geographic locations associated with respective POIs that are reachable via roadway within a threshold amount of time from the respective POIs.

5. The computing system according to claim 1, wherein the instruction code that causes the computing system to generate the geographic region causes the computing system to:
generate a geographic region that comprises an uninterrupted cluster of one or more overlapping isochrone regions associated respectively with one or more POIs of a plurality of POIs.

6. The computing system according to claim 1, wherein the geographic region is a first geographic region and the one or more POIs is a first plurality of POIs, wherein the instruction code that causes the computing system to:
determine one or more routes between the first geographic region and a second geographic region that comprises one or more isochrone regions.

7. The computing system according to claim 6, wherein the instruction code causes the computing system to:
receive a driving skill level indication associated with the particular driver, wherein the instruction code that causes the computing system to determine the one or more routes between the first geographic region and the second geographic region comprises instruction code that causes the computing system to:
determine the one or more routes between the first geographic region and the second geographic region based on the driving skill level indication associated with the particular driver.

8. The computing system according to claim 6, wherein the instruction code causes the computing system to:
after determining that the particular driver has deviated from a particular route of the one or more routes, generate an alert indication.

9. The computing system according to claim 6, wherein a particular route of the one or more routes is associated with one or more isochrone regions, wherein the instruction code causes the computing system to:
after determining that the particular driver has deviated from the particular route and the particular driver is not within the one or more isochrone regions associated with the particular route, generate an alert indication.

10. A non-transitory computer-readable medium having stored thereon instruction code that, when executed by one or more processors of a computing system, causes the computing system to:
receive data indicative of respective locations of one or more points of interest (POIs);
generate a geographic region that comprises one or more isochrone regions associated respectively with one or more POIs of a plurality of POIs; and
after determining that a particular driver has traveled outside the geographic region, communicate an alert indication.

11. The non-transitory computer-readable medium according to claim 10, wherein the instruction code that causes the computing system to receive data indicative of the respective locations of the one or more POIs causes the computing system to:
receive location data that specifies a plurality of geographic locations at which a mobile device was present;
after determining that a number of times the mobile device was present at a particular geographic location exceeds a threshold, indicate the particular geographic location as a point of interest (POI).

12. The non-transitory computer-readable medium according to claim 10, wherein the one or more isochrone regions comprise respective areas around geographic locations associated with respective POIs that are reachable via roadway within a threshold amount of time from the respective POIs.

13. The non-transitory computer-readable medium according to claim 10, wherein the instruction code that causes the computing system to generate the geographic region causes the computing system to:
generate a geographic region that comprises an uninterrupted cluster of one or more overlapping isochrone regions associated respectively with one or more POIs of a plurality of POIs.

14. The non-transitory computer-readable medium according to claim 10, wherein the geographic region is a first geographic region and the plurality of POIs is a first plurality of POIs, wherein the instruction code that causes the computing system to:
determine one or more routes between the first geographic region and a second geographic region that comprises one or more isochrone regions.

15. The non-transitory computer-readable medium according to claim 14, wherein the instruction code causes the computing system to:
receive a driving skill level indication associated with the particular driver, wherein the instruction code that causes the computing system to determine the one or more routes between the first geographic region and the second geographic region comprises instruction code that causes the computing system to:
determine the one or more routes between the first geographic region and the second geographic region based on the driving skill level indication associated with the particular driver.

16. The non-transitory computer-readable medium according to claim 14, wherein the instruction code causes the computing system to:
after determining that the particular driver has deviated from a particular route of the one or more routes, generate an alert indication.

17. The non-transitory computer-readable medium according to claim 14, wherein a particular route of the one or more routes is associated with one or more isochrone regions, wherein the instruction code causes the computing system to:
after determining that the particular driver has deviated from the particular route and the particular driver is not within the one or more isochrone regions associated with the particular route, generate an alert indication.

18. The non-transitory computer-readable medium according to claim 10, wherein the instruction code that causes the computing system to communicate an alert indication causes the computing system to:
communicate an alert indication to one or more of: a mobile device of the particular driver and a mobile device of a different user.

19. A computing-implemented method comprising:
receiving data indicative of respective locations of one or more points of interest (POIs);
generating a geographic region that comprises one or more isochrone regions associated respectively with one or more POIs of a plurality of POIs; and
after determining that a particular driver has traveled outside the geographic region, communicating an alert indication.

20. The computing-implemented method according to claim 19, wherein the geographic region is a first geographic region and the plurality of POIs is a first plurality of POIs, wherein the method further comprises:
determining one or more routes between the first geographic region and a second geographic region that comprises one or more isochrone regions associated respectively with one or more POIs of a second plurality of POIs.
